(19) United States
(12) Patent Application Publication
(10) Pub. No.: US 2026/0217218 A1
(43) Pub. Date: Jul. 30, 2026

(54) AUTHENTICATION SYSTEM FOR VEHICLES

(71) Applicant: TRINAMIX GMBH, Ludwigshafen (DE)

(72) Inventors: Muhammad Muneeb HASSAN, Ludwigshafen (DE); Christian HESS, Ludwigshafen (DE)

(21) Appl. No.: 19/152,035

(22) PCT Filed: Jan. 26, 2024
(86) PCT No.: PCT/EP24/51907

§ 371 Date: Jul. 30, 2025

(30) Foreign Application Priority Data
Feb. 15, 2023 (EP) 23156723.1

(51) Int. Cl. B60R 25/10; B60K 35/28; B60R 25/01; B60R 25/25; B60R 25/30; B60R 25/31

(52) U.S. Cl. CPC B60R 25/10; B60K 35/28; B60R 25/01; B60R 25/25; B60R 25/305; B60R 25/31; B60K 2360/16; B60K 2360/332; B60K 2360/334

(57) ABSTRACT

Disclosed herein are a method for automated quality control of at least one photodetector, a photodetector for measuring optical radiation and a spectrometer for spectrally analyzing optical radiation provided by at least one object.
Further disclosed herein are a computer program and a computer-readable storage medium for performing the method.

The invention is in the field of authentication system for vehicles. It relates to a authentication system for vehicles, the use of the authentication system for controlling the vehicle, a vehicle containing the authentication system, a method for authenticating a person in a vehicle and a non-transient computer-readable medium including instructions for the method for authenticating a person in a vehicle.

### BACKGROUND

Traditionally, a user authentication in a vehicle is done via a key, so any user who has the right key is deemed authorized. In this way a theft of the key can access the vehicle, start the engine and use all other functionalities of the vehicle. As keys can be stolen easily, more sophisticated methods for controlling a vehicle are desirable.

WO 2021/218180 A1 discloses a method for controlling unlocking of a vehicle door involving evaluating a face image detection of a person. CN 114120484 A discloses a facial recognition system for judging whether a person is a legitimate user. In both cases, a camera is visibly attached to the car. This has the disadvantage that a theft can more easily recognize the face authentication system and may more easily find ways to circumvent such a system.

### SUMMARY

It was therefore the object of the present invention to provide an authentication system for vehicles which does not have the disadvantages of the prior art.

This object was achieved by an authentication system for vehicles comprising
a transparent display attached to the vehicle,
a projector positioned such that it can illuminate light through the transparent display to a person,
a camera positioned such that it can receive light from the person through the transparent display, and
a processor which receives an image from the camera and is configured to determine if the imaged person is an authorized person, wherein the processor is configured to output a signal indicating if the imaged person is authorized.

The present invention further relates to the use of the authentication system of the present invention for controlling the vehicle.

The present invention further relates to a vehicle containing the authentication system according to the present invention.

The present invention further relates to a method for authenticating a person in a vehicle comprising
illuminating the person with light through a transparent display attached to the vehicle,
recording an image of the person through the transparent display,
determining if the imaged person is an authorized person, and
outputting a signal indicating if the imaged person is authorized.

The present invention further relates to a non-transient computer-readable medium including instructions that, when executed by one or more processors, cause the one or more processors to perform the method according to present invention.
[symbol] illuminating the person with light through a transparent display attached to the vehicle,
recording an image of the person through the transparent display,
determining if the imaged person is an authorized person, and
outputting a signal indicating if the imaged person is authorized.

In another aspect, it relates to a method for determining a condition of a driver, the method comprising:
triggering to illuminate the driver with light through a transparent display attached to the vehicle;
triggering to record an image of the driver through the transparent display while the driver is being illuminated by the light;
determining a condition measure associated with a condition of the driver based on the image;
providing the condition measure.

In another aspect, it relates to a method for accessing a vehicle and/or a function of the vehicle, the method comprising:
triggering to illuminate a person with light through a transparent display attached to the vehicle;
triggering to record an image of the person through the transparent display while the driver is being illuminated by the light;
determining if the person corresponds to an authorized person based the image; and
allowing the person to access the vehicle and/or the function of the vehicle based on determining that the person is authorized.

By placing both a projector and a camera behind a transparent display, the authentication system is not visible to a user. The projector and camera can be placed at any place behind the display. If more than one display is present which is more and more common in modern vehicles, it is even not apparent in which display the authentication system is placed. This makes it harder for thefts to manipulate the vehicle. In addition, placing projector and camera behind a display has the advantage that the authentication system does not need extra space on the surface, for example on a dashboard. This allows designers to use the space otherwise and gives more freedom for an appealing appearance. Also, hiding a projector and a camera has the advantage that the driver is less detracted and may feel less monitored.

The authentication system is suitable for various vehicles including cars, motorcycles, buses, trucks, trains or even airplanes.

The authentication system contains a transparent display. The term “display” may refer to an arbitrary shaped device configured for displaying an item of information. The item of information may be arbitrary information such as at least one image, at least one diagram, at least one his-togram, at least one graphic, text, numbers, at least one sign, or an operating menu. The display may be or may comprise at least one screen. The display may have an arbitrary shape, e.g. a rectangular shape. The display may be a front display of the device.

The display may be or may comprise at least one organic light-emitting diode (OLED) display. The term “organic light emitting diode” may refer to a light-emitting diode (LED) in which an emissive electroluminescent layer is a film of organic compound configured for emitting light in response to an electric current. The OLED display may be configured for emitting visible light. The display, particularly a display area, may be covered by glass. In particular, the display may comprise at least one glass cover.

The transparent display is at least partially transparent. The term “at least partially transparent” may refer to a property of the display to allow light, in particular of a certain wavelength range, e.g. in the infrared spectral region, in particular in the near infrared spectral region, to pass at least partially through. For example, the display may be semitransparent in the near infrared region. For example, the display may have a transparency of 20 % to 50 % in the near infrared region. The display may have a different transparency for other wavelength ranges. For example, the display may have a transparency of >80 % for the visible spectral range, preferably >90 % for the visible spectral range. The transparent display may be at least partially transparent over the entire display area or only parts thereof. Typically, it is sufficient if only those parts of the display area are at least partially transparent trough which light needs to pass from the projector or to the camera. In particular, the transparent display may be at least partially transparent where the projector and/or the camera are covered by the display.

The display comprises a display area. The term “display area” may refer to an active area of the display, in particular an area which is activatable. The display may have additional areas such as recesses or cutouts. The display may have a first area associated with a first pixel per inch (PPI) value and a second area associated with a second PPI value. The first PPI value may be lower than the second PPI value, preferably first PPI value is equal to or below 400 PPI, more preferably the second PPI value may be equal to or higher than 300 PPI. The first PPI value may be associated with the at least one continuous area being at least partially transparent.

The transparent display is attached to a vehicle. It can be places at various places, for example on the outside of a vehicle or the inside. When placed outside of the vehicle, it may be integrated into a vehicle body, a door, a window, a mirror or in between windows, for example in the B pillar of a car. When placed inside the vehicle, it may be integrated into the steering wheel, replacing a speed gauge, in the center of a dashboard, in a mirror or in a window.

The authentication system further contains a projector to illuminate light to a person. The term “light” may refer to electromagnetic radiation in one or more of the infrared, the visible and the ultraviolet spectral range. Herein, the term “ultraviolet spectral range”, generally, refers to electromagnetic radiation having a wavelength of 1 nm to 380 nm, preferably of 100 nm to 380 nm. Further, in partial accordance with standard ISO-21348 in a valid version at the date of this document, the term “visible spectral range”, generally, refers to a spectral range of 380 nm to 760 nm. The term “infrared spectral range” (IR) generally refers to electromagnetic radiation of 760 nm to 1000 μm, wherein the range of 760 nm to 1.5 μm is usually denominated as “near infrared spectral range” (NIR) while the range from 1.5 μm to 15 μm is denoted as “mid infrared spectral range” (MidIR) and the range from 15 μm to 1000 μm as “far infrared spectral range” (FIR). Preferably, light used for the typical purposes of the present invention is light in the infrared (IR) spectral range, more preferred, in the near infrared (NIR) and/or the mid infrared spectral range (MidIR), especially the light having a wavelength of 1 μm to 5 μm, preferably of 1 μm to 3 μm.

The term “illuminate” may refer to the process of exposing at least one element to light. The term “projector” may refer to a device configured for generating or providing light in the sense of the above-mentioned definition. The projector may be a pattern projector, a floodlight projector or both either at the same time or the projector may repeatedly switch from illuminating patterned light to floodlight.

The term “pattern projector” may refer to a device configured for generating or providing at least one light pattern, in particular at least one infrared light pattern. The term “light pattern” may refer to at least one pattern comprising a plurality of light spots. The light spot may be at least partially spatially extended. At least one spot or any spot may have an arbitrary shape. In some cases a circular shape of at least one spot or any spot may be preferred. The spots may be arranged by considering a structure of a display comprised by a device that is further comprising the optoelectronic apparatus. Typically, an arrangement of an OLED-pixel-structure of the display may be considered. The term “infrared light pattern” may refer to a light pattern comprising spots in the infrared spectral range. The infrared light pattern may be a near infrared light pattern. The infrared light may be coherent. The infrared light pattern may be a coherent infrared light pattern.

The pattern projector may be configured for emitting light at a single wavelength, e.g. in the near infrared region. In other embodiments, the pattern projector may be adapted to emit light with a plurality of wavelengths, e.g. for allowing additional measurements in other wavelengths channels.

The infrared light pattern may comprise at least one regular and/or constant and/or periodic pattern such as a triangular pattern, a rectangular pattern, a hexagonal pattern or a pattern comprising further convex tilings. For example, the infrared light pattern is a hexagonal pattern, preferably a hexagonal infrared light pattern, preferably a 2/5 hexagonal infrared light pattern.

Using a periodical 2/5 hexagonal pattern can allow distinguishing between artefacts and usable signal.

At least one of the infrared light spots may be associated with a beam divergence of 0.2° to 0.5°, preferably 0.1° to 0.3°. The term “beam divergence” may refer to at least one measure of an increase in at least one diameter and/or at least one diameter equivalent, such as a radius, with a distance from an optical aperture from which the beam emerges. The measure may be an angle or an angle equivalent. In the context of the present invention, typically, a beam divergence may be determined at 1/e².

The pattern projector may comprise at least one pattern projector configured for generating the infrared light pattern. The pattern projector may comprise at least one emitter, in particular a plurality of emitters. The term “emitter” may refer to at least one arbitrary device configured for providing at least one light beam. The light beam may generate the infrared light pattern. The emitter may comprise at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least 50 one diode pumped laser, at least one distributed feedback lasers, at least one quantum well laser, at least one interband cascade laser, at least one semiconductor ring laser, at least one vertical cavity surface emitting laser (VCSEL); at least one non-laser light source such as at least one LED or at least one light bulb. For example, the pattern projector comprises at least one least one VCSEL, preferably a plurality of VCSELs. The plurality of VCSELs may be arranged in at least one array, e.g. comprising a matrix of VCSELs. The VCSELs may be arranged on the same substrate, or on different substrates. The term “vertical-cavity surface-emitting laser” may refer to a semiconductor laser diode configured for laser beam emission perpendicular with respect to a top surface. Examples for VCSELs can be found e.g. in en.wikipedia.org/wiki/Verticalcavity_surface-emitting_laser. VCSELs are generally known to the skilled person such as from WO 2017/222618 A. Each of the VCSELs is configured for generating at least one light beam. The plurality of generated spots may be associated with the infrared light pattern. The VCSELs may be configured for emitting light beams at a wavelength range from 800 to 1000 nm. For example, the VCSELs may be configured for emitting light beams at 808 nm, 850 nm, 940 nm, and/or 980 nm. Preferably the VCSELs emit light at 940 nm, since terrestrial sun radiation has a local minimum in irradiance at this wavelength, e.g. as described in CIE 085-1989 “Solar spectral Irradiance”.

The pattern projector may comprise at least one optical element configured for increasing the number of spots generated by the pattern projector and/or replicating, e.g. duplicating or tripli-cating, the pattern. Other multiplication factors are possible. The pattern projector, particularly the optical element, may comprises at least one diffractive optical element (DOE) and/or at least one metasurface element. The DOE and/or the metasurface element may be configured for generating multiple light beams from a single incoming light beam. Further arrangements, particularly comprising a different number of projecting VCSEL and/or at least one different optical element configured for increasing the number of spots may be possible. For example, a VCSEL or a plurality of VCSELs may be used and the generated laser spots may be duplicated by using at least one DOE.

The pattern projector may comprise at least one transfer device. The term “transfer device”, also denoted as “transfer system” may refer to one or more optical elements which are adapted to modify the light beam, particularly the light beam used for generating at least a portion of the infrared light pattern, such as by modifying one or more of a beam parameter of the light beam, a width of the light beam or a direction of the light beam. The transfer device may comprise at least one imaging optical device. The transfer device specifically may comprise one or more of: at least one lens, for example at least one lens selected from the group consisting of at least one focus-tunable lens, at least one aspheric lens, at least one spherical lens, at least one Fres-nel lens; at least one diffractive optical element; at least one concave mirror; at least one beam deflection element, preferably at least one mirror; at least one beam splitting element, preferably at least one of a beam splitting cube or a beam splitting mirror; at least one multilens system; at least one holographic optical element; at least one meta optical element. Specifically, the transfer device comprises at least one refractive optical lens stack. Thus, the transfer device may comprise a multi-lens system having refractive properties.

The pattern projector may be configured for emitting modulated or non-modulated light. In case a plurality of emitters is used, the different emitters may have different modulation frequencies, e.g. which can be used for distinguishing the light beams.

The light beam or light beams generated by the pattern projector may propagate parallel to an optical axis. The pattern projector may comprise at least one reflective element, preferably at least one prism, for deflecting the illuminating light beam onto the optical axis. As an example, the light beam or light beams, such as the laser light beam, and the optical axis may include an angle of less than 10°, preferably less than 5° or even less than 2°. Other embodiments, however, are feasible. Further, the light beam or light beams may be on the optical axis or off the optical axis. As an example, the light beam or light beams may be parallel to the optical axis having a distance of less than 10 mm to the optical axis, preferably less than 5 mm to the optical axis or even less than 1 mm to the optical axis or may even coincide with the optical axis.

The term “flood projector” may refer to at least one device configured for providing substantially continuous spatial illumination. The flood projector may illuminate a measurement area, such as a user, a portion of the user and/or a face of the user, with a spatially constant or essentially constant illumination intensity. The term “flood light” may refer to substantially continuous spatial illumination, in particular diffuse and/or uniform illumination. The flood light has a wavelength in the infrared range, in particular in the near infrared range. The flood projector may comprise at least one least one VCSEL and/or at least one LED, preferably a plurality of VCSELs and/or LEDs. The term “substantially continuous spatial illumination” may refer to uniform spatial illumination, wherein areas of non-uniform are possible.

A relative distance between the flood projector and the pattern projector may be below 3.0 mm. The relative distance between the flood projector and the pattern projector may be below 2.5 mm, preferably below 2.0 mm. The pattern projector and the flood projector may be combined into one module. For example, the pattern projector and the flood projector may be arranged on the same substrate, in particular having a minimum relative distance. The minimum relative distance may be defined by a physical extension of the flood projector and the pattern projector.

Arranging the pattern projector and the flood projector having a relative distance below 3.0 mm can result in decreased space requirement of the two projectors. In particular, said projectors can even be combined into one module. Such a reduced space requirement can allow reducing the transparent area(s) in a display necessary for operation of the projector(s) behind the display.

In an embodiment, the pattern projector and the flood projector may comprise at least one VCSEL, preferably a plurality of VCSELs. The pattern projector may comprise a plurality of first VCSELs mounted on a first platform. The flood projector may comprise a plurality of second VCSELs mounted on a second platform. The second platform may be beside the first platform. The optoelectronic apparatus may comprise a heat sink. Above the heat sink a first increment comprising the first platform may be attached. Above the heat sink a second increment comprising the second platform may be attached. The second increment may be different from the first increment. Thus, the first platform may be more distant to the optical element configured for increasing, e.g. duplicating, the number of spots. The second platform may be closer to the optical element. The beam emitted from the second VCSEL may be defocused and thus, form overlapping spots. This leads to a substantially continuous illumination and, thus, to flood illumination.

The projector is positioned such that it can illuminate light through the transparent display. Hence, light emitted by the projector crosses the transparent display before it impinges on the person. From the person's view, the projector is placed behind the transparent display.

The authentication system further comprises a camera. The term “camera” may refer to at least one unit of the optoelectronic apparatus configured for generating at least one image. The image may be generated via a hardware and/or a software interface, which may be considered as the camera. The term “image generation” may refer to capturing and/or generating and/or determining and/or recording at least one image by using the camera. The image generation may comprise imaging and/or recording the image. The image generation may comprise capturing a single image and/or a plurality of images such as a sequence of images. For generating an image via a hardware and/or a software interface, the capturing and/or generating and/or determining and/or recording of the image may be caused and/or initiated by the hardware and/or the software interface. For example, the image generation may comprise recording continuously a sequence of images such as a video or a movie. The image generation may be initiated by a user action or may automatically be initiated, e.g. once the presence of at least one object or user within a field of view and/or within a predetermined sector of the field of view of the camera is automatically detected.

The camera may comprise at least one optical sensor, in particular at least one pixelated optical sensor. The camera may comprise at least one CMOS sensor or at least one CCD chip. For example, the camera may comprise at least one CMOS sensor, which may be sensitive in the infrared spectral range. The term “image” may refer to data recorded by using the optical sensor, such as a plurality of electronic readings from the CMOS or CCD chip. The image may comprise raw image data or may be a pre-processed image. For example, the pre-processing may comprise applying at least one filter to the raw image data and/or at least one background correction and/or at least one background subtraction.

For example, the camera may comprise a color camera, e.g. comprising at least color pixels. The camera may comprise a color CMOS camera. For example, the camera may comprise black and white pixels and color pixels. The color pixels and the black and white pixels may be combined internally in the camera. The camera may comprise may comprise at least one color camera (e.g. RGB) and/or at least one black and white camera, such as a black and white CMOS. The camera may comprise at least one black and white CMOS chip. The camera generally may comprise a one-dimensional or two-dimensional array of image sensors, such as pixels. The camera may comprise an IR camera, in particular a NIR camera. The camera may comprise an IR sensitive CMOS chip and/or CCD chip, preferably a CMOS chip and/or CCD chip sensitive in the NIR range.

The color camera may be an internal and/or external camera of a device comprising the optoelectronic apparatus. The internal and/or external camera of the device may be accessed via a hardware and/or a software interface comprised by the optoelectronic apparatus, which is used as the camera. In case, the device is or comprises a smartphone the image generating unit may be a front camera, such as a selfie camera, and/or back camera of the smartphone.

The camera may have a field of view between 10°×10° and 75°×75°, preferably 55°×65°. The camera may have a resolution below 2 MP, preferably between 0.3 MP and 1.5 MP.

The camera may comprise further elements, such as one or more optical elements, e.g. one or more lenses. As an example, the optical sensor may be a fix-focus camera, having at least one lens which is fixedly adjusted with respect to the camera. Alternatively, however, the camera may also comprise one or more variable lenses which may be adjusted, automatically or manually. Other cameras, however, are feasible.

The term “pattern image” may refer to an image generated by the camera while illuminating the infrared light pattern, e.g. on an object and/or a user. The pattern image may comprise an image showing a user, in particular at least parts of the face of the user, while the user is being illuminated with the infrared light pattern, particularly on a respective area of interest comprised by the image. The pattern image may be generated by imaging and/or recording light reflected by an object and/or user which is illuminated by the infrared light pattern. The pattern image showing the user may comprise at least a portion of the illuminated infrared light pattern on at least a portion the user. For example, the illumination by the pattern illumination source and the imaging by using the optical sensor may be synchronized, e.g. by using at least one control unit of the optoelectronic apparatus.

The term “flood image” may refer to an image generated by the camera while illumination source is illuminating infrared flood light, e.g. on an object and/or a user. The flood image may comprise an image showing a user, in particular the face of the user, while the user is being illuminated with the flood light. The flood image may be generated by imaging and/or recording light reflected by an object and/or user which is illuminated by the flood light. The flood image showing the user may comprise at least a portion of the flood light on at least a portion the user. For example, the illumination by the flood illumination source and the imaging by using the optical sensor may be synchronized, e.g. by using at least one control unit of the optoelectronic apparatus.

The camera may be configured for imaging and/or recording the pattern image and the flood image at the same time or at different times. The camera may be configured for imaging and/or recording the pattern image and the flood image at at least partially overlapping measurement areas or equivalents of the measurement areas.

The camera is positioned such that it can receive light from the person through the transparent display. Light reflected or refracted from the person firstly crosses the transparent display before it impinges on the camera. From the person's view, the camera is placed behind the transparent display.

The authentication system further comprises a processor. The processor may be an logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations. At least one or any component of a computer program configured for performing the authentication process may be executed by the processing device. Alternatively or in addition, the processor may be or may comprise a connection interface. The connection interface may be configured to transfer data from the device to a remote device; or vice versa. At least one or any component of a computer program configured for performing the authentication process may be executed by the remote device.

The processor specifically may be configured, such as by software programming, for performing one or more evaluation operations. At least one or any component of a computer program configured for performing the authentication process may be executed by the processing device. Alternatively or in addition, the processor may be or may comprise a connection interface. The connection interface may be configured to transfer data from the device to a remote device; or vice versa. At least one or any component of a computer program configured for performing the authentication process may be executed by the remote device.

The processor may be configured for identifying the user based on the flood image. Particularly therefore, the processor may forward data to a remote device. Alternatively or in addition, the processor may perform the identification of the user based on the flood image, particularly by running an appropriate computer program having a respective functionality. The term “identifying” may refer to identity check and/or verifying an identity of the user. The identifying of the user may comprise analyzing the flood image. The analyzing of the flood image may comprise performing a face verification of the imaged face to be the user's face. The identifying the user may comprise matching the flood image, e.g. showing a contour of parts of the user, in particular parts of the user's face, with a template. Determining if the imaged face is the face of the user may comprise identifying the user, in particular determining if the imaged face corresponds to at least one image of the user's face stored in at least one memory, e.g. of the device.

The analyzing may comprise one or more of the following: a filtering; a selection of at least one region of interest; a formation of a difference image between the flood image and at least one offset; an inversion of flood image; a background correction; a decomposition into color channels; a decomposition into hue; saturation; and brightness channels; a frequency decomposition; a singular value decomposition; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transfor-mation; applying a wavelet-transformation; a thresholding; creating a binary image. The region of interest may be determined manually by a user or may be determined automatically, such as by recognizing the user within the image. In particular, the analyzing of the flood image may comprise using at least one image recognition technique, in particular a face recognition technique. An image recognition technique comprises at least one process of identifying the user in an image. The image recognition may comprise using at least one technique selected from the technique consisting of: color-based image recognition, e.g. using features such as hue, saturation, and value (HSV) or red, green, blue (RGB); template matching, for example as illustrated on https://www.mathworks.com/help/vision/ug/pattern-matching.html; image segment and/or blob analysis e.g. using size, color, or shape; machine learning and/or deep learning e.g. using at least one convolutional neural network. The neural network may be trained by the user, such as in a training procedure, in which the user is indicated to take at least one or a plurality of pic-tures showing himself.

The analyzing of the flood image may comprise determining a plurality of facial features. The analyzing may comprise comparing, in particular matching, the determined facial features with template features. The template features may be features extracted from at least one template. The template may be or may comprise at least one image generated in an enrollment process, e.g. when initializing the authentication system. The template may be an image of an authorized user. The template features and/or the facial feature may comprise a vector. Matching of the features may comprise determining a distance between the vectors. The identifying of the user may comprise comparing the distance of the vectors to a least one predefined limit, wherein the user is successfully identified in case the distance is smaller than or equal to the predefined limit at least within tolerances. The user declining or rejected otherwise.

For example, the image recognition may comprise using at least one model, in particular a trained model comprising at least one face recognition model. The analyzing of the flood image may be performed by using a face recognition system, such as FaceNet, e.g. as described in Florian Schroff, Dmitry Kalenichenko, James Philbin, “FaceNet: A Unified Embedding for Face Recognition and Clustering”, arXiv: 1503.03832. The trained model may comprises at least one convolutional neural network. For example, the convolutional neural network may be designed as described in M. D. Zeiler and R. Fergus, “Visualizing and understanding convolutional networks”, CoRR, abs/1311.2901, 2013, or C. Szegedy et al., “Going deeper with convolutions”, CoRR, abs/1409.4842, 2014. For more details with respect to convolutional neural network for the face recognition system reference is made to Florian Schroff, Dmitry Kalenichenko, James Philbin, “FaceNet: A Unified Embedding for Face Recognition and Clustering”, arXiv: 1503.03832. As training data labelled image data from an image database may be used. Specifically, labeled faces may be used from one or more of G. B. Huang, M. Ramesh, T. Berg, and E. Learned-Miller, “Labeled faces in the wild: A database for studying face recognition in unconstrained environments”, Technical Report 07-49, University of Massachusetts, Amherst, October 2007, the Youtube® Faces Database as described in L. Wolf, T. Hassner, and I. Maoz, “Face recognition in unconstrained videos with matched background similarity”, in IEEE Conf. on CVPR, 2011, or Google® Facial Expression Comparison dataset. The training of the convolutional neural network may be performed as described in Florian Schroff, Dmitry Kalenichenko, James Philbin, “FaceNet: A Unified Embedding for Face Recognition and Clustering”, arXiv: 1503.03832.

The processor may be configured to correct image artifacts caused by diffraction of the light when passing the transparent display. The term “correct” may mean partially or fully remove the artifacts or tag them so they can be excluded from further processing, in particular from determine if the imaged person is an authorized person. Correcting image artifacts may take into account the information about the transparent display, in particular the dimensions of the pixels or the distance of repeating features to each other. Correcting image artifacts may include determining artifacts and removing determined artifacts prior to analysis. Image artifacts comprise a lower intensity or irradiance in comparison to the directly radiated light. Thus, the intensity or irradiance may be used to determine whether a light spot is an artifact or not. To increase the accuracy of determining whether a light spot is an artifact or not, the intensity or irradiance of a spot emitted from the illumination source may be increased. Further, diffraction of a certain type of patten such as a hexagonal pattern may simplify the identification of artifacts and directly radiated light.

This information can facilitate identifying artifacts as diffraction patterns can be calculated and compared to the image. Correcting image artifacts may comprise identifying reflection features, sorting them by brightness and selecting the locally brightest features. For determining a distance around a feature in the image which qualifies as local, the information of the transparent display may be used, in particular a distance in the image by which a light beam may be dis-placed by diffraction on the transparent display may be calculated based on the information about the transparent display. This method can be particularly useful for pattern images. Further details are disclosed in WO 2021/105265 A1.

The processor may be configured to determine the quality of the image from the camera. Determination of the quality of the image can mean determining the brightness of the image, in particular determining if the brightness of the image is within a predetermined range. This predetermined range may be selected such that image recognition yields optimum results. The processor may generate a signal indicative of the brightness level of the image. Such signal may be use, for example by a controller of the projector, to adjust the illumination power of the projector. The signal may also be used by a controller of the camera to adjust the camera settings according to the signal indicative of the brightness level and/or trigger the camera to generate a new image. Determination of the quality of the image can also mean determining the head position of the person, in particular determining the angle of the face of the person relative to the camera. It may be determined if the angle of the face of the person relative to the camera is within a predetermined range. This predetermined range may be selected such that image recognition yields optimum results. The processor may generate a signal indicative of the head position of the person. Such signal may be used, for example by a controller of the camera to trigger the camera to generate a new image. The signal may also be used to inform the user to turn the head, for example by displaying such information on the transparent display.

In an embodiment, the processor may determine the quality of the image based on brightness of the image. Determining the quality based on brightness may include determining at least on brightness value. For example, ambient light may influence the quality of the image negatively and detecting an overexposed image hinders false authentication based on the overexposed image.

The processor may be further configured for determining material data based on the pattern image. Particularly therefore, the processor may forward data to a remote device. Alternatively or in addition, the processor may perform the material determination based on the pattern image, particularly by running an appropriate computer program having a respective functionality. Particularly by considering the material as a parameter for validating the authentication process, the authentication process may be robust against being outwitted by using a recorded image of the user.

The processor may be configured for extracting the material data from the pattern image by beam profile analysis of the light spots. With respect to beam profile analysis reference is made to WO 2018/091649 A1, WO 2018/091638 A1 and WO 2018/091640 A1, the full content of which is included by reference. Beam profile analysis can allow for providing a reliable classification of scenes based on a few light spots. Each of the light spots of the pattern image may comprise a beam profile. The term “beam profile” may generally refer to at least one intensity distribution of the light spot on the optical sensor as a function of the pixel. The beam profile may be selected from the group consisting of a trapezoid beam profile; a triangle beam profile; a conical beam profile and a linear combination of Gaussian beam profiles.

The processor may be configured for outsourcing at least one step of the authentication process, such as the identification of the user, and/or at least one step of the validation of the authentication process, such as the consideration of the material data, to a remote device, specifically a server and/or a cloud server. The authentication system and the remote device may be part of a computer network, particularly the internet. The authentication system may transmit the generated data and/or data associated to an intermediate step of the authentication process and/or its validation to the remote device. In such a scenario, the processor may be and/or may comprise a connection interface configured for transmitting information to the remote device. Data generated by the remote device used in the authentication process and/or its validation may further be transmitted to the authentication system. This data may be received by the connection interface comprised by the authentication system. The connection interface may specifically be configured for transmitting or exchanging information. In particular, the connection interface may provide a data transfer connection, e.g. Bluetooth, NFC, or inductive coupling. As an example, the connection interface may be or may comprise at least one port comprising one or more of a network or internet port, a USB-port, and a disk drive.

The processor is configured for using a facial recognition authentication process operating on the pattern image and/or extracted material data. The processor may be configured for extracting material data from the pattern image.

In an embodiment, extracting material data from the pattern image may comprise generating the material type and/or data derived from the material type. Preferably, extracting material data may be based on the pattern image. Material data may be extracted by using at least one model. Extracting material data may include providing the pattern image to a model and/or receiving material data from the model. Providing the image to a model may comprise and may be followed by receiving the pattern image at an input layer of the model or via a model loss function. The model may be a data-driven model. Data-driven model may comprise a convolutional neural network and/or an encoder decoder structure such as an autoencoder. Other examples for generating a representation may be FFT, wavelets, deep learning, like CNNs, energy models, normalizing flows, GANs, vision transformers, or transformers used for natural language processing, Autoregressive Image Modeling, Normalizing Flows, Deep Autoencoders, Deep En-ergy-Based Models. Supervised or unsupervised schemes may be applicable to generate a representation, also embedding in e.g. cosine or Euclidian metric in ML language. The data-driven model may be parametrized according to a training data set including at least one image and material data, preferably at least one pattern image and material data. In another embodiment, extracting material data may include providing the image to a model and/or receiving material data from the model. In another embodiment, the data-driven model may be trained according to a training data set including at least one image and material data. In another embodiment, the data-driven model may be parametrized according to a training data set including at least one image and material data. The data-driven model may be parametrized according to a training data set to receive the image and provide material data based on the received image. The data-driven model may be trained according to a training data set to receive the image and provide material data as output based on the received image. The training data set may comprise at least one image and material data, preferably material data associated with the at least one image. The image may comprise a representation of the image. The representation may be a lower dimensional representation of the image. The representation may comprise at least a part of the data or the information associated with the image. The representation of an image may comprise a feature vector. In an embodiment, determining a representation, in particular a lower-dimensional representation may be based on principal component analysis (PCA) mapping or radial basis function (RBF) mapping. Determining a representation may also be referred to as generating a representation. Generating a representation based on PCA mapping may include clustering based on features in the pattern image and/or partial image. Additionally or alternatively, generating a representation may be based on neural network structures suitable for reducing dimensionality. Neural network structures suitable for reducing dimensionality may comprise an encoder and/or decoder. In an example, neural network structure may be an auto-encoder. In an example, neural network structure may comprise a convolutional neural network (CNN). The CNN may comprise at least one convolutional layer and/or at least one pooling layer. CNNs may reduce the dimensionality of a partial image and/or an image by applying a convolution, e.g. based on a convolutional layer, and/or by pooling. Applying a convolution may be suitable for selecting feature related to material information of the pattern image.

In an embodiment, a model may be suitable for determining an output based on an input. In particular, model may be suitable for determining material data based on an image as input. A model may be a deterministic model, a data-driven model or a hybrid model. The deterministic model, preferably, reflects physical phenomena in mathematical form, e.g., including first-principles models. A deterministic model may comprise a set of equations that describe an interaction between the material and the patterned electromagnetic radiation thereby resulting in a condition measure, a vital sign measure or the like. A data-driven model may be a classification model. A hybrid model may be a classification model comprising at least one machine-learning architecture with deterministic or statistical adaptations and model parameters. Statistical or deterministic adaptations may be introduced to improve the quality of the results since those provide a systematic relation between empiricism and theory. In an embodiment, the data-driven model may be a classification model. The classification model may comprise at least one machine-learning architecture and model parameters. For example, the machine-learning architecture may be or may comprise one or more of: linear regression, logistic regression, random forest, piecewise linear, nonlinear classifiers, support vector machines, naive Bayes classifications, nearest neighbors, neural networks, convolutional neural networks, generative adversarial networks, support vector machines, or gradient boosting algorithms or the like. In the case of a neural network, the model can be a multi-scale neural network or a recurrent neural network (RNN) such as, but not limited to, a gated recurrent unit (GRU) recurrent neural network or a long short-term memory (LSTM) recurrent neural network. The data-driven model may be parametrized according to a training data set. The data-driven model may be trained based on the training data set. Training the model may include parametrizing the model. The term training may also be denoted as learning. The term specifically may refer to a process of building the classification model, in particular determining and/or updating parameters of the classification model. Updating parameters of the classification model may also be referred to as retraining. Retraining may be included when referring to training herein. In an embodiment, the training data set may include at least one image and material information.

In an embodiment, determining if the imaged person may be an authorized person may include a material classification and/or a blood perfusion classification. Material classification may include extracting material data from an image generated by the camera and validating the extracted material data. In an embodiment, blood perfusion classification may include determining a blood perfusion measure based on an image generated by the camera and validating the blood perfusion measure. Validating the blood perfusion measure may include determining if the determined blood perfusion measure corresponds to a desired blood perfusion measure. Desired blood perfusion measure may be a blood perfusion measure associated with the authorized user. Determining if the determined blood perfusion measure corresponds to a desired blood perfusion measure may include comparing the determined blood perfusion measure with the desired blood perfusion measure. If the determined blood perfusion measure corresponds to the desired blood perfusion measure, the authentication may be validated. If the determined blood perfusion measure is outside of a range specified by the desired blood perfusion measure, the authentication may be invalidated.

In an embodiment, the light may be coherent light, in particular patterned infrared illumination may be coherent patterned infrared illumination. Determining a blood perfusion measure may comprise determining a speckle contrast of the pattern image and determining a blood perfusion measure based on the determined speckle contrast. A speckle contrast may represent a measure for a mean contrast of an intensity distribution within an area of a speckle pattern. In particular, a speckle contrast K over an area of the speckle pattern may be expressed as a ratio of standard deviation o to the mean speckle intensity <|>, i.e.,

$$K = \frac{σ}{〈 I 〉}$$

Speckle contrast may comprise a speckle contrast value. Speckle contrast values may be distributed between 0 and 1. The blood perfusion measure is determined based on the speckle contrast. Thus, the vital sign measure may depend on the determined speckle contrast. If the speckle contrast changes, the blood perfusion measure derived from the speckle contrast may change accordingly. A blood perfusion measure may be a single number or value that may represent a likelihood that the object is a living subject. Preferably, for determining the speckle contrast, the complete pattern image may be used. Alternatively, for determining the speckle contrast, a section of the pattern image may be used. The section of the pattern image, preferably, represents a smaller area of the pattern image than an area of the complete pattern image. The section of the pattern image may be obtained by cropping the pattern image. Blood perfusion measure may indicate whether a living human is detected.

In an embodiment, extracting material data may comprise providing the image to a data-driven model. Additionally or alternatively, extracting material data may comprise generating a numerical representation associated with the image by the data-driven model and/or mapping the numerical representation associated with the image to the material data. The numerical representation associated with the image may be a feature vector. Extracting material data may comprise generating an embedding associated with the image based on the data-driven model The data-driven model may be parametrized and/or trained based on historical images and corresponding historical material data. The data-driven model may be configured to provide material data in response to receiving an image, eg generated by the camera. An embedding may refer to a lower dimensional representation associated with the image such as a feature vector. Feature vector may be suitable for suppressing the background while maintaining the material signature indicating the material data. In this context, background may refer to information independent of the material signature and/or the material data. Further, background may refer to information related to biometric features such as facial features. Material data may be determined with the data-driven model based on the embedding associated with the image. Additionally or alternatively, extracting material data from the image by providing the image to a data-driven model may comprise transforming the image into material data, in particular a material feature vector indicating the material data. Hence, material data may comprise further the material feature vector and/or material feature vector may be used for determining material data.

In an embodiment, authentication process may be validated based on the extracted material data.

In an embodiment, the validating based on the extracted material data may comprise determining if the extracted material data corresponds to a desired material data. Determining if extracted material data matches the desired material data may be referred to as validating. Allowing or rejecting the user and/or object to perform at least one operation on the device that requires authentication based on the material data may comprise validating the authentication or authentication process. Validating may be based on material data and/or image. Determining if the extracted material data corresponds to a desired material data may comprise determining a similarity of the extracted material data and the desired material data. Determining a similarity of the extracted material data and the desired material data may comprise comparing the extracted material data with the desired material data. Desired material data may refer to predetermined material data. In an example, desired material data may be skin. It may be determined if material data may correspond to the desired material data. In the example, material data may be non-skin material or silicon. Determining if material data corresponds to a desired material data may comprise comparing material data with desired material data. A comparison of material data with desired material data may result in a allowing and/or rejecting the user and/or object to perform at least one operation that requires authentication. In the example, skin as desired material data may be compared with non-skin material or silicon as material data and the result may be rejection since silicon or non-skin material may be different from skin.

In an embodiment, the authentication process or its validation may include generating at least one feature vector from the material data and matching the material feature vector with associate reference template vector for material.

In an embodiment, person, in particular authorized person and/or user, may refer to an enrolled person and/or a registered person. Enrolled person may be a person having undergone an en-rolment process. Enrollment process may be a process for generating a template, in particular a template suitable for comparison with the recorded image of the person with the camera placed behind the transparent display.

In an embodiment, the illuminating and/or the recording may be initiated and/or triggered by a request for authentication, preferably a request for payment. In particular, the illuminating and/or the recording may be initiated and/or triggered by a payment terminal. Preferably, the illuminating and/or the recording may be initiated and/or triggered by at least one of the person, the device associated with the person, an application of the device associated with the person or a combination thereof. Device associate with the person may refer to a mobile electronic communication device such as a smartphone.

The authentication unit may be configured for authenticating the user in case the user can be identified and/or if the material data matches the desired material data. The device may comprise at least one authorization unit configured for allowing the user to perform at least one operation on the device, e.g. unlocking the device, in case of successful authentication of the user or rejecting the user to perform at least one operation on the device in case of non-successful authentication. Thereby, the user may become aware of the result of the authentication.

In a further aspect, the present invention discloses a method for authenticating a user of a device to perform at least one operation on the device that requires authentication.

The processor is configured to output a signal indicating if the imaged person is authorized. This signal may be a binary signal, wherein a zero may represent the information that the person is not authorized and a one represents that the person is authorized. The signal may also be a number, for example an integer or a float value indicating a probability if the person is authorized.

The signal may be transferred to a control section which controls a function of the vehicle. The control section may, for example, based on the signal unlock the vehicle, start the engine, grant access to a board computer system, verify an insurance policy, connect to a remote network, or verify an electronic payments, for example to pay fuel, parking fees, toll, vehicle rental fees, or digital services such as in app stores. In this way, the authentication system of the present invention may be used for controlling the vehicle.

The present invention further relates to a method for authenticating a person in a vehicle. Unless explicitly described differently in the following, the description including preferred embodiments described above apply to the method.

All described method steps may be performed by hardware in the vehicle. Therefore, determining if the imaged person is an authorized person a processor may be configured to exclusively perform at least one computer program, in particular at least one line of computer program code configured to execute at least one algorithm, as used in at least one of the embodiments of the method according to the present invention. Herein, the computer program as executed on the single processing device may comprise all instructions causing the computer to carry out the method. Alternatively, or in addition, at least one method step may be performed by using at least one remote device, especially selected from at least one of a server or a cloud server, particularly when the device and the remote device may be part of a computer network. In this case, the computer program may comprise at least one remote component to be executed by the at least one remote processing device to carry out the at least one method step. The remote component may have the functionality of performing the identification of the user and/or the extraction of the material data. Further, the computer program may comprise at least one interface configured to forward to and/or receive data from the at least one remote component of the computer program.

The present invention further relates to a non-transient computer-readable medium including instructions that, when executed by one or more processors, cause the one or more processors to perform the method according to the present invention. The term “computer-readable data medium” may refer to any suitable data storage device or computer readable memory on which is stored one or more sets of instructions (for example software) embodying any one or more of the methodologies or functions described herein. The instructions may also reside, completely or at least partially, within the main memory and/or within the processor during execution thereof by the computer, main memory, and processing device, which may constitute computer-readable storage media. The instructions may further be transmitted or received over a network via a network interface device. Computer-readable data medium include hard drives, for example on a server, USB storage device, CD, DVD or Blue-ray discs. The computer program may contain all functionalities and data required for execution of the method according to the present invention or it may provide interfaces to have parts of the method processed on remote systems, for example on a cloud system.

In an embodiment, the authentication system may include one or more, preferably two or more component(s). The authentication system may be an apparatus configured for authenticating a user of the apparatus. The component(s) may be and/or may comprise a transparent display attached to the vehicle, a projector positioned such that it can illuminate light through the transparent display to a person, a camera positioned such that it can receive light from the person through the transparent display, and/or a processor which receives an image from the camera and is configured to determine if the imaged person is an authorized person, wherein the processor is configured to output a signal indicating if the imaged person is authorized.

In an embodiment, triggering to record may comprise triggering to record at least two images of the driver through the transparent display while the driver is being illuminated by the light. The at least two images may be generated at at least two different points in time. Further, an indication of at least one interval between at least two different points in time may be provided. The condition measure associated with a condition of the driver may be determined based on the at least two pattern images and the indication of the at least one interval.

In an embodiment, providing the determined condition measure may include determining if the determined condition measure may correspond to a target condition measure and allowing the driver to control at least one function of the vehicle in response to determining that the determined condition measure may correspond to the target condition measure.

In an embodiment, determining a condition measure associated with a condition of the driver based on the at least two pattern images and the indication of the at least one interval may comprise providing the at least two pattern images and the indication of the at least one interval to a condition model. The condition model may be a data-driven model, in particular based on a statistical distribution between pattern images, indications on intervals and condition measures. The condition model may be parametrized and/or trained based on historical pattern images, historical indications on intervals and historical condition measures. The condition model may be parametrized and/or trained to determine condition measures in response to being provided with at least two pattern images and at least one indication of the interval.

A condition measure may be a measure suitable for determining the condition of a living organism. A condition of a living organism may be a physical and/or mental condition. A physical condition may be associated with physical stress level, fatigue, excitation, suitability of performing a certain task of a living organism or the like. A mental condition may be associated with mental stress level, attentiveness, concentration level, excitation, suitability of performing a certain task of a living organism or the like. Such a certain task may require concentration, attention, wakefulness, calming or similar characteristics of the living organism. Examples for such a task can be controlling machinery, vehicle, mobile device or the like, operating on another living species, activities relating to sports, playing games, tasks in an emergency case, making decisions or the like. Condition measures indicate a condition of a living organism. Condition measures may be one or several of the following: heart rate, blood pressure, aspiration level or the like. In some embodiments, the condition of a living organism may be critical corresponding to a high value of the condition measure and the condition of a living organism may be non-critical corresponding to a low value of the condition measure. Followingly, the critical condition measure according to these embodiments may be equal or lower than a threshold and a non-critical condition measure may be lower than a threshold. In other embodiments, the condition of a living organism may be critical corresponding to a low value of the condition measure and the condition of a living organism may be non-critical corresponding to a high value of the condition measure. Followingly the critical condition measure according to these embodiments may be equal or higher than a threshold and a non-critical condition measure may be lower than a threshold. A critical condition measure may be associated with a high stress level, low attentiveness, low concentration level, high fatigue, high excitation, low suitability of performing a certain task of the living organism or the like. A non-critical condition measure may be associated with a low stress level, high attentiveness, high concentration level, low fatigue, low excitation, high suitability of performing a certain task of the living organism or the like.

The condition measure of a living organism may be determined based on the motion of a body fluid, preferably blood, most preferably red blood cells. The motion of body fluids is not constant over time but changes due to activity of parts of the living organism, e.g the heart. Such a change in motion may be determined based on a change in feature contrast over time. A high difference between values of feature contrast at different points in time may be associated with a fast change in motion. A low difference between values of feature contrast at different points in time may be associated with a slow change in motion. The change in motion of a body fluid, preferably blood, may be periodically associated with a corresponding motion frequency. Accordingly, the feature contrast may change periodically with the corresponding motion frequency. The motion frequency may correspond to the length of a period associated with the periodic change in feature contrast. In some embodiments, half of a period may be comprised in the at least two reflection images. In other embodiments, one or several periods may be comprised in the at least two reflection images. Preferably, pattern feature associated with the same part of a living organism may be used for determining the condition of a living organism. This is advantageous due to the fact that the blood perfusion and thus, the feature contrast across different parts of the body varies. In some embodiments, at least one condition measure may be determined based on the feature contrast.

### BRIEF DESCRIPTION OF THE FIGURES

FIG. 1 shows the elements of the authentication system.

FIG. 2 shows possible placements of the authentication system on the outside of a car.

FIG. 3 shows possible placements of the authentication system inside a car.

FIG. 4 shows the authentication of a driver in a car.

### DESCRIPTION OF EMBODIMENTS

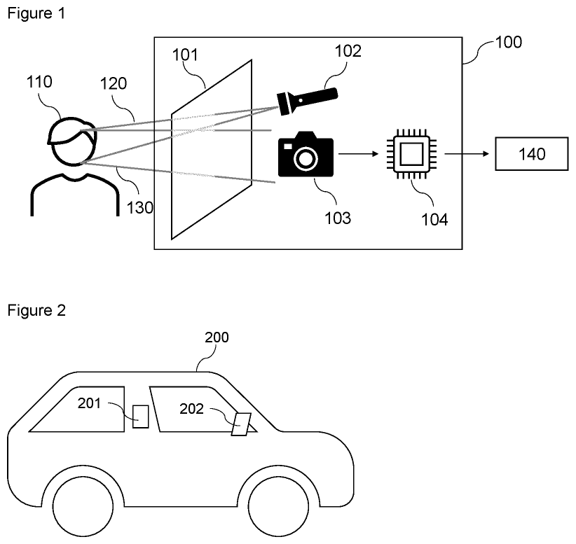

FIG. 1 illustrates the elements of the authentication system 100 which is attached to a vehicle. It contains the transparent display 101 which allows light 120 to pass from the projector 102 to a person 110. The light may be infrared light which is invisible to the person. The transparent display 101 may only be transparent at the positions at which light 120, 130 passes. Transparent may mean that at least 30 % or at least 50 % of the incident light passes through the transparent display 101. The transparent display 101 further allows reflected light 130 which was reflected by the person 110 to pass to the camera 103. The light 120 may impinge on the face of the person, but it may also impinge on the whole head including hair, the upper part of the body including head neck and shoulders or even the complete body. The camera 103 generates an image in the optical range matching the wavelength emitted by projector 102, for example in the infrared range. The image may be a grayscale image, i.e. each pixel contains only the total intensity information, or an RGB image, i.e. different pixels indicate the intensity in a particular wavelength. The image is passed to processor 104. The processor 104 may be a microcontrol-ler, i.e. containing memory and IO controller functionalities or it may be a CPU which is con-nected to memory and IO controllers. The processor 104 determines if the person is an authorized person. Such determination may involve vectorizing the image into features. Such feature vector may be compared to a stored template. If the difference between the feature vector and the stored template is below a predefined threshold, the processor may determine that the person in the vehicle is authorized. The processor may further determine if the image really shows a human rather than a spoofing mask. This may be accomplished by classifying the material of the face in the image by evaluating reflection characteristics in the reflected light. If no skin is detected, the processor may determine that the person in front of the transparent display is not authorized. The processor may generate a signal 140 indicating that the person in the vehicle is authorized. The signal 140 may be forwarded to a controller for unlocking of the vehicle, starting an engine, granting access to the board computer or effecting a secure payment, for example via a wireless communication interface.

FIG. 2 indicates potential positions where the transparent display may be attached to a vehicle on the outside, for example a car 200. The display may be placed between the windows in the B pillar 201. Alternatively or additionally, the transparent display may be places in the side mirror 202.

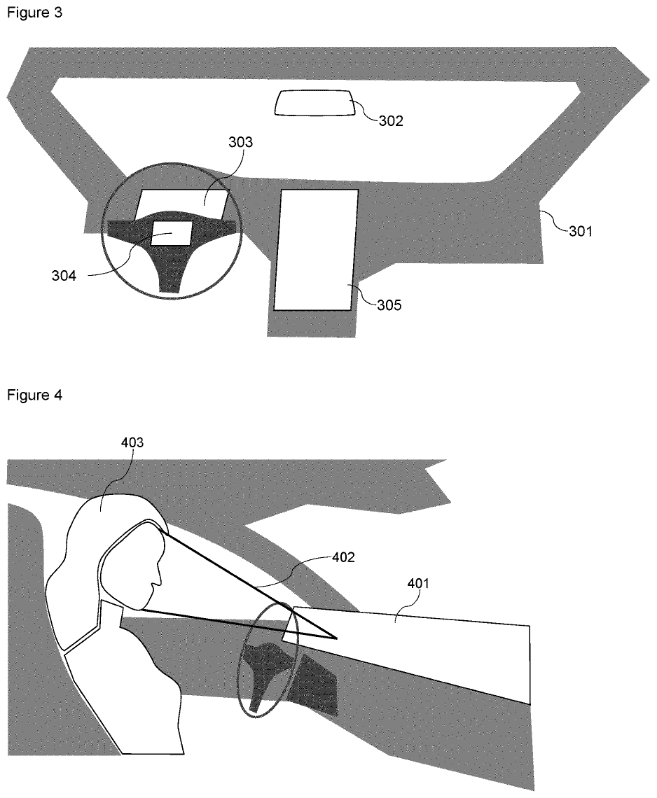

FIG. 3 indicated potential positions where the transparent display may be attached on the inside of a vehicle. The figure shows a dashboard 301 and the windshield of a car as seen from the inside of the car. The transparent display may be integrated into the interior mirror 302. This may be particularly useful if the mirror functionality is only mimicked by a display which displays the rear view recorded by a camera. Another possibility is space behind the steering wheel 303 where the gauges such as the speed gauge are typically placed. Furthermore, the transparent display may also be integrated into the steering wheel 304. The center console 305 is another option as replacing traditional controls with a display become more and more popular. In an embodiment, space behind the steering wheel 303 and the center console may be combined in a continuous display.

FIG. 4 shows an authentication system in the inside of a car. The transparent display 401 is placed behind the steering wheel into the dashboard. Light rays 402 are emitted onto the face of the driver 403. The light reflected by the person 403 may pass through the transparent display 401 where it is recorded by a camera which generates an image which is analyzed by a processor to determine if the person is an authorized person.

1. An authentication system for vehicles comprising
a transparent display attached to the vehicle,
a projector positioned such that it can illuminate light through the transparent display to a person,
a camera positioned such that it can receive light from the person through the transparent display, and
a processor which receives an image from the camera and is configured to determine if the imaged person is an authorized person, wherein the processor is configured to output a signal indicating if the imaged person is authorized.

2. The authentication system according to claim 1, wherein the transparent display contains organic light-emitting diodes.

3. The authentication system according to claim 1, wherein the projector illuminates infrared light through the transparent display to a person.

4. The authentication system according to claim 1, wherein the projector illuminates patterned light and floodlight through the transparent display to a person.

5. The authentication system according to claim 1, wherein the projector comprises an array of vertical cavity surface-emitting lasers.

6. The authentication system according to claim 1, wherein the projector comprises at least one metasurface element and/or at least one diffractive optical element.

7. The authentication system according to claim 1, wherein determine if the imaged person is an authorized person includes
extracting material data from an image generated by the camera and validating the extracted material data and/or
determining a blood perfusion measure from the image generated by the camera and validating the blood perfusion measure.

8. The authentication system according to claim 1, wherein image artifacts caused by diffraction of the light when passing the transparent display are corrected.

9. The authentication system according to claim 1, wherein determining if the imaged person is an authorized person includes a determination of the head position of the person.

10. A method of using the authentication system of claim 1, the method comprising using the authentication system for controlling the vehicle.

11. The method of using the authentication system according to claim 10, wherein the authentication system is used for unlocking the vehicle, starting the engine, granting access to a board computer system, connecting to a remote network, or verifying an electronic payment.

12. A vehicle containing the authentication system according to claim 1.

13. A method for authenticating a person in a vehicle comprising
illuminating the person with light through a transparent display attached to the vehicle,
recording an image of the person through the transparent display,
determining if the imaged person is an authorized person, and
outputting a signal indicating if the imaged person is authorized.

14. The method according to claim 13, wherein the signal is used to control the vehicle.

15. A non-transient computer-readable medium including instructions that, when executed by one or more processors, cause the one or more processors to perform the method according to claim 13.
